(19) United States
(12) Patent Application Publication
(10) Pub. No.: US 2008/0147966 A1
(43) Pub. Date: Jun. 19, 2008

(54) FLASH MEMORY DEVICE, UPDATE METHOD AND PROGRAM SEARCH METHOD THEREOF

(75) Inventors: Chun-Ting Liao, Hsinchu 300 (TW); Dong-Yu He, Hsinchu 300 (TW); Guang-Huan Zhao, Hsinchu 300 (TW)

Correspondence Address: ROSENBERG, KLEIN & LEE, 3458 ELLICOTT CENTER DRIVE-SUITE 101, ELLICOTT CITY, MD, 21043, US

(73) Assignee: REALTEK SEMICONDUCTOR CORP., HSINCHU 300 (TW)

(21) Appl. No.: 11/958,682

(22) Filed: Dec. 18, 2007

(30) Foreign Application Priority Data
Dec. 19, 2006 (TW) 095147707

(51) Int. Cl. G06F 12/02

(52) U.S. Cl. 711/103; 711/E12.008

(57) ABSTRACT

The present invention discloses a flash memory device, an update method and program search method thereof. The flash memory device includes a read-only memory unit, a flash memory unit and a control unit. The read-only memory unit is used to store a first program code. The flash memory unit is used to store a second program code and digital data. The control unit coupled to the flash memory unit and the read-only memory unit is used to control the operation of the flash memory unit based on the first program code and the second program code. Hence, the upgrade time for the flash memory device can be shortened and the manufacture cost can be reduced.

### FIELD OF THE INVENTION

The present invention relates to a flash memory device, update method and program search method thereof, and more particularly to a technique of storing a program into a flash memory unit to the facilitation of updating a flash memory device of the program.

### BACKGROUND OF THE INVENTION

Flash memory is a popular data storage medium primarily used for portably exchanging data among electronic devices (such as a personal computer) by way of universal serial bus (USB) interface or other common interfaces, and commonly seen flash memory standards include flash disk, SD card, Compact Flash card and SmartMedia card, etc. Since flash memory can store data with high reliability, security, and convenience, it is used extensively with various electronic products including mobile phone, digital camera, digital camcorder, and MP3 player, and these products usually use flash memory as data storage medium.

Most of the conventional flash memory devices include a microcontroller unit (MCU), and the program code to be executed is stored in a read-only memory (ROM). This scheme is simple, but it has the following drawbacks. Firstly, new flash memory products are constantly introduced to the market and thus all kinds of upgrade programs for various models provided by different manufacturers are required to support new flash memory products. Secondly, new functions are added from time to time in order to satisfy customer needs, and thus it is necessary to edit the programs frequently. However, because conventionally the programs are stored in a read-only memory, it becomes inevitable to modify the hardware when every time updating a program, and the software development and testing for such update usually take several months before mass production. As a result, a higher production cost and a longer manufacturing time are incurred.

### SUMMARY OF THE INVENTION

It is a one of the objectives of the present invention is to provide a flash memory device, an update method and a program search method thereof, and specifically a technique of storing a program into a flash memory unit to the facilitation of updating the flash memory device of the program.

To achieve the foregoing objective, the present invention provides a flash memory device comprising a read-only memory unit, a flash memory unit, and a control unit, wherein the read-only memory unit is provided for storing a first program code, and the flash memory unit is provided for storing a second program code and digital data. The control unit is coupled to the read-only memory unit and the flash memory unit to control the operation of the flash memory device based on the first program code and the second program code.

The flash memory device, the update method, and the program search method in accordance with the present invention divide the program to be executed into two portions, wherein one portion is stored in the read-only memory unit and needs not to be modified after leaving the factory, and the other portion is stored in the flash memory unit and can be updated anytime. Such an arrangement can improve the convenience of updating the programs and reduce the time and cost for system upgrades without affecting the product performance.

To make it easier for readers to understand the objective of the invention, its structure, innovative features, and performance, we use a preferred embodiment together with the attached drawings for the detailed description of the invention.

### BRIEF DESCRIPTION OF THE DRAWINGS

The subject matter regarded as the invention is particularly pointed out and distinctly claimed in the concluding portion of the specification. The invention, both as to device and method of operation, together with features and advantages thereof may best be understood by reference to the following detailed description with the accompanying drawings in which:

FIG. 1 is a schematic view of a memory space allocation of a program code stored in a flash memory device in accordance with a preferred embodiment of the present invention;

FIG. 2 is a schematic view of a flash memory device in accordance with a preferred embodiment of the present invention;

FIG. 3 is a flow chart of a program search method of a flash memory device in accordance with a preferred embodiment of the present invention;

FIG. 4 is a schematic view of a memory space allocation of an internal random access memory in accordance with a preferred embodiment of the present invention;

FIG. 5 is a schematic view of an update system of a flash memory device in accordance with a preferred embodiment of the present invention; and

FIG. 6 is a flow chart of an update method of a flash memory device in accordance with a preferred embodiment of the present invention.

### DETAILED DESCRIPTION OF THE PREFERRED EMBODIMENTS

In describing a preferred embodiment of a flash memory device, an update method, and a program search method in accordance with the invention illustrated in the drawings, specific terminologies and numerals will be resorted for the sake of clarity. However, the invention is not intended to be limited to the specific terms and numerals so selected, and it is to be understood that each specific term includes all technical equivalents which operate in a similar manner to accomplish a similar purpose. It is noteworthy to point out that a flash memory device employed in this embodiment is illustrated by a commonly used flash disk connected a computer system with a universal serial bus (USB) interface for data transmissions, but the persons skilled in that art should understand that the invention is not limited to such arrangement, and any other device that uses a flash memory for storage can be used for the same purpose.

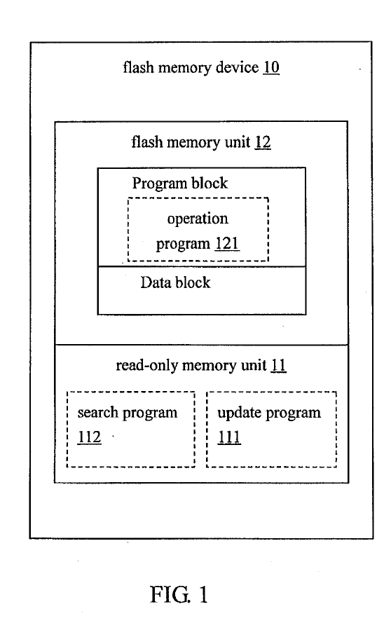

Referring to FIG. 1 for a schematic view of a memory space allocation of a program code stored in a flash memory device in accordance with a preferred embodiment of the present invention is illustrated. The memory space allocation of storing a program code executable by a microcontroller unit (not shown in the figure) is for controlling a flash memory device 10 as shown in FIG. 1. The memory space of the flash memory device 10 mainly includes a read-only memory unit 11 and a flash memory unit 12, wherein the read-only memory unit 11 is provided for storing a basic program of the program code executed by the microcontroller unit, such as a search program 112 and an update program 111. The flash memory device 10 can further store a universal serial bus (USB) certification program. The memory space of the flash memory unit 12 is divided into a data block and a program block, wherein the data block is used primarily as a main memory space of the flash memory device 10 for storing general data, and the program block is provided for storing other operation programs 121 of the program code executed by the microcontroller unit. The operation program 121 includes various program codes for operating the flash memory device 10, and the search program 112 includes the program codes for searching the program block, and the update program 111 includes the program codes for updating the operation program 121.

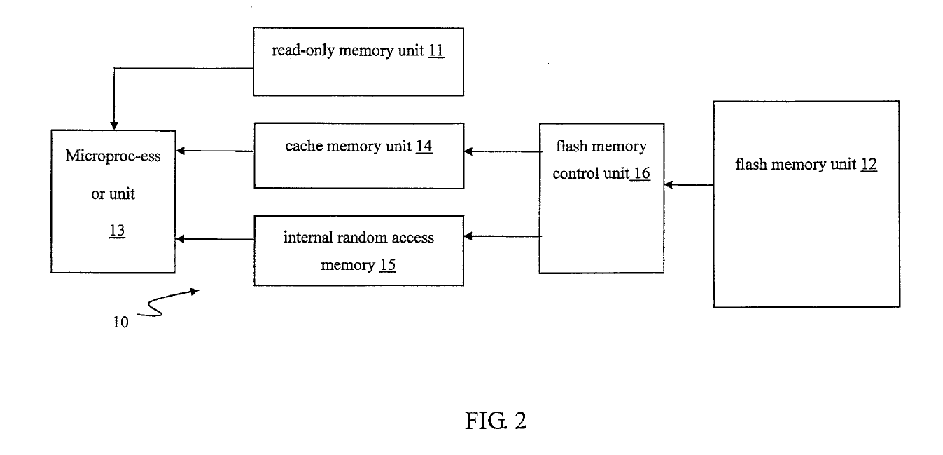

Referring to FIG. 2 for a schematic view of a flash memory device in accordance with a preferred embodiment of the present invention, the flash memory device includes a read-only memory unit 11, a flash memory unit 12, a microprocessor unit 13, a cache memory unit 14, an internal random access memory (IRAM) 15, and a flash memory control unit 16. The read-only memory unit 11 is provided for storing a basic program such as the search program 112 and an update program 111. T he flash memory unit 12 is provided for storing other operation programs 121 and general data, and the flash memory control unit 16 is provided for controlling an access operation of the flash memory unit 12. After receiving an external command, the microprocessor unit 13 searches and executes a program code corresponding to the external command from the read-only memory unit 11, the cache memory unit 14, the internal random access memory 15, or the flash memory unit 12 to operate the flash memory device 10.

To reduce the frequency of accessing the flash memory unit 12 during the process of searching and executing the foregoing program codes, in order to shorten the overall operation time, the flash memory device 10 of this embodiment uses the cache memory unit 14 and the internal random access memory 15 as buffers for reading the program codes. Since the microcontroller unit 13 retrieves a program code from the flash memory unit 12 through the cache memory unit 14, the cache memory unit 14 will keep previously buffered program codes. If the microcontroller unit 13 needs to again retrieve a piece of previously read program code in the flash memory unit 12, the program code can be read directly from the cache memory unit 14 without spending time on accessing the flash memory unit 12 again. The internal random access memory 15 reads and temporarily stores the expected program codes, which are frequently used, from the flash memory unit 12 in advance based on the information of manufacturers and types, such that when the microcontroller unit 13 would like to retrieve these program codes which are frequently used, the program codes can be directly read from internal random access memory 15 without spending time on accessing the flash memory unit 12.

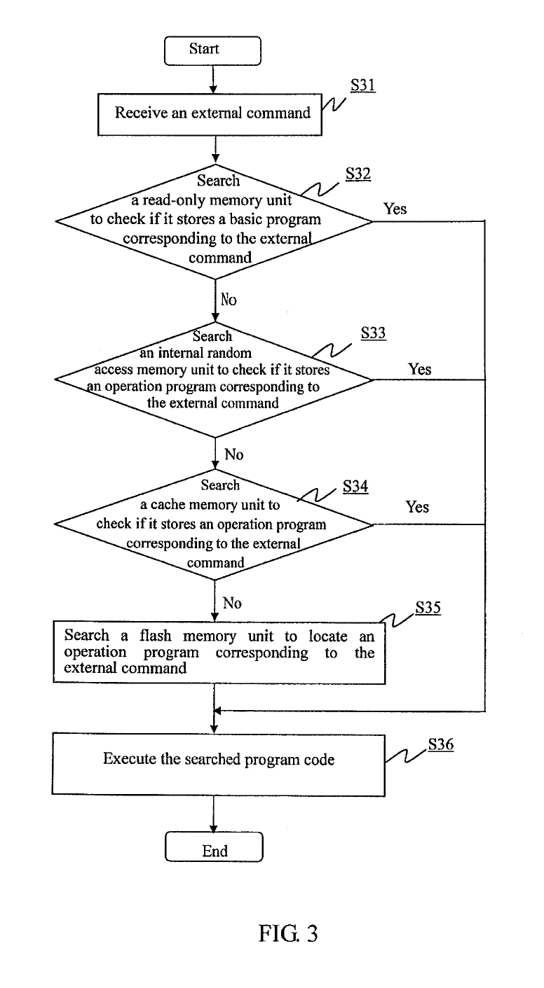

Referring to FIG. 3 for a flow chart of a program search method of a flash memory device in accordance with a preferred embodiment of the present invention, the method comprises the steps of:

Step S31: receiving an external command;

Step S32: searching a read-only memory unit to check if it stores a basic program corresponding to the external command; if yes, then end searching, or else go to Step S33;

Step S33: searching an internal random access memory unit to check if it stores an operation program corresponding to the external command; if yes, then end searching, or else go to Step S34;

Step S34: searching a cache memory unit to check if it stores an operation program corresponding to the external command; if yes, then end searching, or else go to Step S35;

Step S35: searching a flash memory unit to locate an operation program corresponding to the external command; and

Step S36: executing the searched program code.

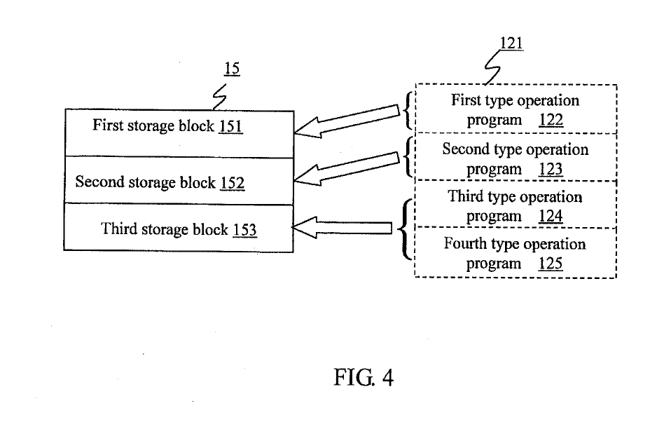

Referring to FIG. 4 for a schematic view of a memory space allocation of an internal random access memory in accordance with a preferred embodiment of the present invention, the operation program 121 stored in the flash memory unit 12 is divided into four types and stored in different blocks of the flash memory unit 12 separately to minimize the size of the internal random access memory unit 15 and improve the access performance of the internal random access memory unit 15. The four types of operation programs 12 include: a first type operation program 122 which is universally used for all types of flash memory units and for both reading and writing access; a second type operation program 123 which is used for a certain type of flash memory unit and for both reading and writing access; a third type operation program 124 which is used for reading a certain type of flash memory unit; and a fourth type operation program 125 which is used for writing a specific type of flash memory unit. Correspondingly, the internal random access memory unit 15 is divided into three storage blocks, wherein a first storage block 151 stores the first type operation program 122, a second storage block 152 stores the second type operation program 123, and a third storage block 153 stores the third type operation program 124 or the fourth type operation program 125.

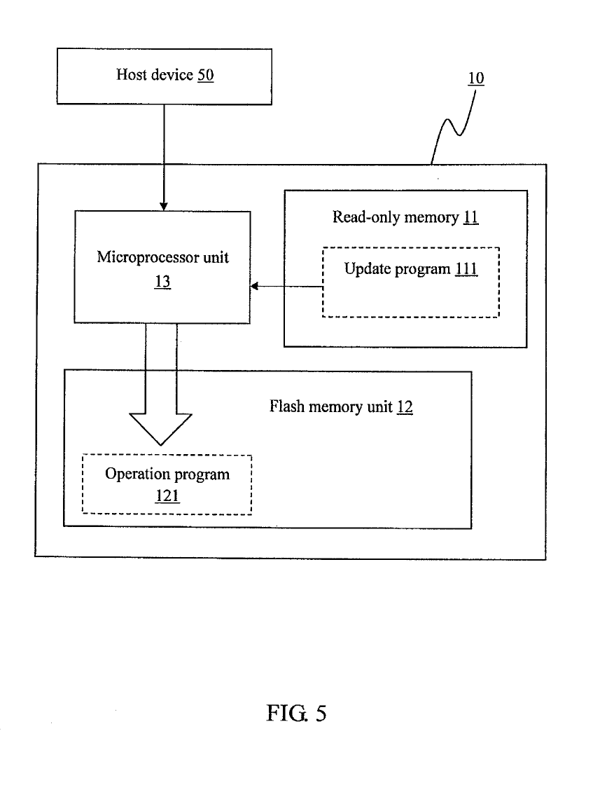

Referring to FIG. 5 for a schematic view of an updating system of a flash memory device in accordance with a preferred embodiment of the present invention, the updating system adopts a flash memory device 10 and a host device 50 (such as a personal computer). The flash memory device 10 comprises a microprocessor unit 13, a flash memory unit 12, and a read-only memory unit 11, wherein the flash memory unit 12 is provided for storing an operation program 121, and the read-only memory unit 11 is provided for storing an update program 111. The host device 50 contains a driver program for updating, and sends an update command and a new operation program to the microprocessor unit 13. The microprocessor unit 13 then overwrites the original operation program 121 to replace the new operation program based on the update program 111.

The function of the host device 50 further comprises transmitting a manufacturer parameter, a model parameter and an operation parameter of the flash memory unit 12 to the microprocessor unit 13, so that the microprocessor unit 13 operates the flash memory unit 12 based on the manufacturer parameter, the model parameter, and the operation parameter. The host device 50 and the microprocessor unit 13 examine the accuracy of the operation program after the new operation program is written into the flash memory unit 12.

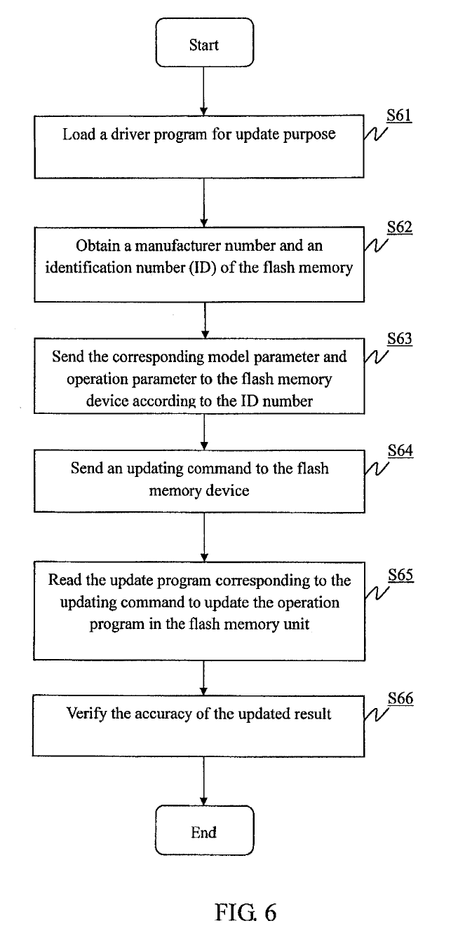

Referring to FIG. 6 for a flow chart of an update method of a flash memory device in accordance with a preferred embodiment of the present invention, the method comprises the steps of:

Step S61: loading a driver program for update purpose;

Step S62: obtaining a manufacturer number and an identification number (ID) of the flash memory;

Step S63: sending the corresponding model parameter and operation parameter to the flash memory device according to the ID number;

Step S64: sending an updating command to the flash memory device;

Step S65: reading the update program corresponding to the updating command to update the operation program in the flash memory unit; and

Step S66: verifying the accuracy of the updated result.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A flash memory device, comprising:
a read-only memory unit for storing a first program code;
a flash memory unit for storing a second program code and digital data; and
a control unit coupled to said read-only memory unit and said flash memory unit, and for controlling the operation of said flash memory device based on said first program code and said second program code.

2. The flash memory device of claim 1, wherein said first program code comprises a search program for searching said second program code in said flash memory.

3. The flash memory device of claim 1, wherein said first program code comprises an update program for updating said second program code in said flash memory.

4. The flash memory device of claim 1, wherein said control unit is a microcontroller unit.

5. The flash memory device of claim 1, further comprising a flash memory control unit coupled to said flash memory unit to control an access operation of said flash memory unit.

6. The flash memory device of claim 1, further comprising a cache memory unit coupled said flash memory unit and said control unit to temporarily store a piece of said second program code.

7. The flash memory device of claim 1, further comprising a random access memory unit coupled between said flash memory unit and said control unit to temporarily store a piece of said second program code.

8. An update method of a flash memory device, comprising:
providing a flash memory unit storing a first operation program;
providing a read-only memory unit storing an update program;
downloading a second operation program through a host device;
sending said second operation program to an update equipment through said host device; and
deleting said first operation program of said flash memory unit, and writing said second operation program into said flash memory unit through said update equipment based on said update program.

9. The update method of a flash memory device of claim 8, wherein said host device further transmits a model parameter and an operation parameter to said update equipment, so that said update equipment operates said flash memory unit based on said model parameter and said operation parameter.

10. The update method of a flash memory device of claim 8, wherein said first operation program is an original operation program, and said second operation program is an update operation program.

11. The update method for a flash memory device of claim 8, wherein said host device and said update equipment checks the accuracy of said second operation program after said second operation program is written into said flash memory unit.

12. A program search method of a flash memory device, comprising:
(a) receiving an external command;
(b) searching a read-only memory unit to determine whether or not said read-only memory unit has a basic program corresponding to said external command; if yes, then end searching, or else go to Step (c); and
(c) searching a flash memory unit to locate an operation program corresponding to said external command.

13. The program search method of a flash memory device of claim 12, further comprising a step of searching a random access memory unit to determine whether or not said random access memory unit has said operation program corresponding to said external command before Step (c) is carried out; if yes, then end searching.

14. The program search method of a flash memory device of claim 12, further comprising a step of searching a cache memory unit to determine whether or not said cache memory unit has said operation program corresponding to said external command before Step (c) is carried out; if yes, then end searching.

15. The program search method of a flash memory device of claim 12, wherein said basic program comprises a basic verification program, an update program and a search program for universal serial bus (USB).

16. The program search method of a flash memory device of claim 12, wherein said operation program is classified into a first type operation program, a second type operation program, a third type operation program and a fourth type operation program.

17. The program search method of a flash memory device of claim 16, wherein said first type operation program is used for all operations required by all types of said flash memory unit, and reading and writing said jointly used operation program; and said second type operation program is provided for a type of said flash memory unit to read and write said jointly used operation program; and said third type operation program is provided for a type of said flash memory unit to read and operate said operation program; and said fourth type operation program is provided for a type of said flash memory unit to write and operate said operation program.

18. The program search method of a flash memory device of claim 13, wherein said operation program is classified into a first type operation program, a second type operation program, a third type operation program and a fourth type operation program.

19. The program search method of a flash memory device of claim 18, wherein said random access memory unit is divided into a first storage block, a second storage block and a third storage block, and said first storage block is provided for storing said first type operation program, and said second storage block is provided for storing said second type operation program, and said third storage block is provided for storing said third type operation program or said fourth type operation program.
